(19) United States
(12) Patent Application Publication
(10) Pub. No.: US 2012/0003049 A1
(43) Pub. Date: Jan. 5, 2012

(54) Pipeline Weighting Device and Method

(75) Inventors: Ian Sprague, Sherwood Park (CA); Charles Frederick McKay, Edmonton (CA)

(73) Assignee: CRC-EVANS CANADA LTD., Edmonton (CA)

(21) Appl. No.: 12/977,652

(22) Filed: Dec. 23, 2010

Related U.S. Application Data
(63) Continuation-in-part of application No. 11/840,089, filed on Aug. 16, 2007, now Pat. No. 7,862,256.

(51) Int. Cl. F16L 1/06

(52) U.S. Cl. 405/184.4

(57) ABSTRACT

A pipeline weighting device to straddle the longitudinal axis of a pipeline adapted to be lifted by transverse lifting straps. The pipeline weighting device includes three or more interconnected, generally tubular-shaped fabric lobes arranged to straddle the pipeline in a balanced manner along its longitudinal axis. Adjacent lobes are interconnected by a longitudinal seam, and are arranged as one or more left outermost lobes, one or more right outermost lobes and one or more innermost lobes. Central transverse lifting straps extend around the innermost lobe(s). Left transverse lifting straps form a loop around the left outermost lobe(s). Right transverse lifting straps form a loop around the right outermost lobe(s). Left transverse lifting straps interconnect to the central transverse lifting strap, and right transverse lifting straps interconnect to the central transverse lifting strap. Also provided is a method of weighting a pipeline with a pipeline weighting device which includes fastening strap and buckle device.

### CROSS-REFERENCE TO RELATED APPLICATION

This application is a Continuation-In-Part of co-pending U.S. patent application Ser. No. 11/840,089, filed Aug. 16, 2007, and which is incorporated herein in its entirety to the extent there is no inconsistency with the present disclosure.

### FIELD OF THE INVENTION

This invention relates to a pipeline weighting device a method of filling such a device with weighting fill material, and a method of weighting a pipeline with such a device.

### BACKGROUND

Pipelines transporting liquid or gaseous materials often extend through areas where the pipeline needs to be weighted to avoid having the pipeline being lifted or heaved by buoyant forces or frost. Such areas include, for example, underwater, marsh, muskeg, and other unconsolidated environments. A trench is typically formed, the pipeline is installed in the trench, and sections of the pipeline are anchored, coated, or weighted with concrete, clamp on weights, or bag weights filled with weighting fill material. The weighted or anchored pipeline must thereafter resist hydrostatic forces of flooding, or freeze-thaw cycles.

Early pipeline weights included simple or complex concrete or concrete-containing devices which could be placed on or strapped around the pipeline. Exemplary patents include U.S. Pat. No. 2,662,552, issued Dec. 15, 1953 to Rowe et al.; Canadian Patent 1,021,952 issued Dec. 6, 1977 to Bunn; U.S. Pat. No. 4,166,710, issued Sep. 4, 1979 to Spiridonov; Canadian Patent 2,158,801 issued Jul. 14, 1998 to Key-May Industries Ltd.; French Patent Application No. 2,716,251 A1 of Bouygues Offshore Société, published Aug. 18, 1995; and U.S. Pat. No. 5,443,329 issued Aug. 22, 1995 to Spuncon Pty. Ltd. and Marecon Pty.

Bag weights for pipeline weighting have been more recently used. They are advantageous in that they can be filled with inexpensive weighting fill materials such as sand and gravel at remote locations during pipeline installation. The bag weights limit damage to a pipeline protective coating. Exemplary patents include U.S. Pat. No. 3,793,845 issued Feb. 26, 1974 to Keith; Canadian Patent 2,075,006, issued Jul. 16, 2002, to Connors; Canadian Patent 2,277,523 issued Feb. 17, 2004, to Jewell; and U.S. Pat. No. 7,344,338 issued Mar. 18, 2008 to Willis et al.

Several of the bag weights of the above patents present problems in the filling and installation operations. The bag weights, once filled, may be very large and heavy, for example in excess of 10,000 pounds. The Connors' device has side saddle bags that are open along its upper longitudinal edges, making spillage of the fill material problematic. As well, these open bags allow water to enter the bag, causing the bag contents to freeze in cold climates where these bags are often used. Installation of frozen bags is problematic, both in terms of awkward handling, and pipe damage. The Connors' device has been altered from that shown in the patent to include drawstrings, partial stitching or flaps to close or partially close these upper edges. These efforts have complicated both the manufacturing of the bags, and the filling and installation process, without fully addressing the problems of spillage and freezing. The Jewell device requires a difficult under the pipeline strapping and cinching operation to fix the bag weights onto the pipeline. Since the bag weights are placed over the pipeline in the close confines of a trench, the strapping operation can be difficult and dangerous for workers, particularly for very large bags which hang well below the pipe. Both the Connors' and Jewell devices cause difficulties with the large bag sizes, since the bag, to provide the needed weight, enlarge both the depth and width dimensions of the weighted pipeline. This in turn increases the depth and size of the trench that is needed to accommodate the weighted pipeline.

The Willis et al. pipeline weighting device uses a circumferential cinch that requires workers to wrap a strap more than one circumferential distance around the bag weight and around the pipeline, which can be a difficult operation in the confines of the pipeline trench. As noted above, large bag weights that extend either too far above, or too far below the pipeline require the trench to be excavated to depths that may be uneconomical. The Willis et al. device attempts to address this problem by filling with heavy barite material; however, barite material is not always readily available or available at low cost.

As well, the heavy bag weights are typically end filled by suspending the bag weight above ground from the open bag ends, and filling each bag from a filling tube or nozzle extending from an overhead hopper (see for example Canadian Patent 2,431,281, issued Jun. 13, 2006 to Jewell). The bag ends must then be individually rolled over and tied to close the ends, a labor intensive process. As well, the ends can open after tying, spilling fill material.

Lifting straps and/or lifting loops have been used with pipeline bag weights for attachment to a fork lift or a crane to lift the bag weight onto the pipeline to straddle the pipeline. For example, U.S. Pat. No. 7,344,338 to Willis et al. shows a lifting strap extending through ports to encircle the middle sack of a five sack weighting device. The lifting strap provides support to the bottom of the middle sack. In very large size bag weights, the stress placed on the bags and the lifting straps during the lifting operation can be extreme, causing the bags and/or lifting straps to tear at in the fabric, at the seams and/or at any attachment points.

A simple, inexpensive pipeline weighting device is still needed to address one or more of the above-noted problems.

### SUMMARY

A pipeline weighting device is provided to straddle the longitudinal axis of a pipeline. In one embodiment, the device is formed of a plurality of interconnected, generally tubular-shaped lobes arranged to straddle the pipeline in a balanced manner along the longitudinal axis of the pipeline. The lobes are formed of a flexible, water permeable fabric to hold weighting fill material. Each lobe has an inner side wall, opposed and closed longitudinal side edges, and opposed ends, one end being a closed end, and the other end forming an open or partially open filling end. Each lobe is formed with a self-closing filling sleeve or filling flap at the open or partially open filling end, the filling sleeve or flap extending into the interior of the lobe and providing an opening into the lobe in a manner such that, when each of the lobes is fully charged through the opening with the fill material, and the pipeline weighting device is turned on its longitudinal axis, the filling sleeve or filling tube becomes trapped within the fill material to close the lobe and to contain the fill material.

The filling sleeve or filling flap may be fixed to an inner side wall of the lobe, such as by stitching, to prevent dislodgement by the fill material during charging.

In one embodiment includes the self-closing filling flap, the pipeline weighting device includes a pair of facing filling flaps extending into the interior of the lobe and have facing side edges which are fastened together along all or part of their length, for example by stitching. The pair of facing filling flaps may extend into the interior of adjacent lobes, such as two adjacent lobes, in order to fill the adjacent lobes in one filling operation.

In another embodiment, the pipeline weighting device includes a filling sleeve which is fixed, for instance by stitching, to the inner side wall of the lobe to prevent dislodgement by the fill material during charging. The filling sleeve may be formed of the flexible, water permeable fabric and is contiguous with the lobe. The filling sleeve and extends into the interior of the lobe so as to form opposed open sleeve ends, one open sleeve end being an exterior open sleeve end at or adjacent the filling end of the lobe, and the other open sleeve end being an interior open sleeve end which forms the opening into the lobe. The filling sleeve has preferred dimensions such that it extends into the interior of the lobe by a distance which is greater than the opening at the interior open end of the filling sleeve.

In some embodiments, the pipeline weighting device is formed such that one filling sleeve extends into the interior of adjacent lobes in order to fill the adjacent lobes in one filling operation. One filling sleeve is formed between two adjacent lobes such that a portion of the filling sleeve extends into the interior of the adjacent lobes, and is partitioned to form interior open ends which open into each adjacent lobe. This is most efficiently achieved by forming the plurality of lobes from a web of the flexible, water permeable fabric, stitched along a longitudinal axis to form the plurality of lobes arranged in side by side relationship, with each of the plurality of lobes being generally equal in size, the closed side edges and closed ends of each lobe being formed by one or both of folding and stitching of the web. The filling sleeve may be stitched to both fix the filling sleeve to the inner side wall of the lobe and to partition to form the interior open ends into the adjacent lobes. The filling sleeves may be formed from the web to be integral with the lobes, and the filling sleeves are formed by stitching along all or part of their side edges, and folding into the interior of the lobes.

The pipeline weighting device may include an even number of lobes to balance on the pipeline, with one filling sleeve arranged to fill each pair of adjacent lobes. For example, four symmetrical lobes may be formed, with one filling sleeve being provided for each two adjacent lobes.

Additional features of the pipeline weighting device may include first lifting loops connected at the filling end of the lobes, for lifting the weighting device during charging, and second lifting loops connected along the longitudinal side edges of one of the lobes, for lifting the filled weighting device into position to straddle the pipeline, first reinforcing straps stitched longitudinally along the stitching lines forming the lobes, and ending in loops which form the first lifting loops, second reinforcing straps stitched transversely across the lobes, and ending in loops which form the second lifting loops. Optionally, one or more fastening straps are connected to one or more of the lobes to hold the weighting device on the pipeline.

The pipeline weighting device is preferably formed from a single web of woven or non-woven geotextile fabric, most preferably woven polypropylene. The first and second reinforcing straps are preferably formed of a woven or non-woven geotextile strapping material, most preferably woven polypropylene strapping material.

Broadly stated, a method of weighting a pipeline along its longitudinal axis is provided. The method includes:

a) providing a pipeline weighting device comprising a plurality of interconnected, generally tubular-shaped lobes, each lobe having an outer side wall, opposed and closed longitudinal side edges, and opposed ends, one end being a closed end, and the other end forming an open filling end; one or more fastening straps connected along the longitudinal side edge of an outermost lobe, and one or more buckle devices connected to the outer side wall of a lobe which is opposite the outermost lobe to which the one or more fastening straps is connected; and the plurality of lobes being formed of a flexible, water permeable fabric to hold the weighting fill material;

b) charging the plurality of lobes with the weighting fill material through their open or partially open filling ends until each lobe includes a balanced, full charge of the weighting fill material, and closing the open or partially open filling end of each lobe;

c) positioning the pipeline weighting device above the pipeline, with the longitudinal axes of the pipeline weighting device and the pipeline being aligned, such that the plurality of lobes are balanced on the pipeline; and

d) fastening the pipeline weighting device to the pipeline by threading the one or more fastening straps through the one or more buckle devices.

Also provided is a pipeline weighting device for straddling a longitudinal axis of a pipeline, including three or more interconnected, generally tubular-shaped lobes arranged in side by side relationship to straddle the pipeline in a balanced manner along the longitudinal axis of the pipeline. Each lobe has an outer side wall, opposed and closed longitudinal side edges, and opposed ends, one end being a closed end and the other end forming an open filling end adapted to receive a weighting fill material prior to closing. The lobes are formed of a flexible water permeable fabric to hold a weighting fill material. The lobes are interconnected one to another by a longitudinal seam along the longitudinal side edges, and the lobes are arranged as one or more left outermost lobes, one or more right outermost lobes and one or more innermost lobes to straddle the pipeline in the balanced manner. The device includes one or more central transverse lifting straps extending transversely and extending around the one or more innermost lobes; one or more left transverse lifting straps, each being transversely aligned with one of the one or more central transverse lifting straps, and extending around the one or more left outermost lobes; and one or more right transverse lifting straps, each being transversely aligned with one of the one or more central transverse lifting straps, and extending around the one or more right outermost lobes. Each of the one or more left transverse lifting straps is interconnected with one of the one or more central transverse lifting straps at the longitudinal seam connecting the one or more left outermost lobes to the one or more innermost lobes. Each of the one or more right transverse lifting straps is interconnected with one of the one or more central transverse lifting straps at the longitudinal seam connecting the one or more right outermost lobes to the one or more innermost lobes.

As used herein and in the claims, the terms “longitudinal”, “centre”, “side” etc. are meant to describe the pipeline weighting device when in place on the longitudinal axis of the pipeline, with side referring to a longitudinal edge, parallel to a longitudinal axis. The ends of the bag or lobe may be referred to as closed, filling or open ends, these ends being along the width, or transverse edges of the bag or lobe, unless the context otherwise requires. The ends are also sometime referred to as “top”, “bottom”, these being the positions when the device is in an upright filling position. “Top” and “bottom” may also refer to a top surface or a bottom surface of the pipeline weighting device, as viewed in top or bottom plan views. “Interior” refers to location within the inner side wall of the bag or lobe, and “exterior” and “outer” refer to locations outside the bag or lobe, such as on an outer side wall. “Left” and “right” are used herein and in the claims with reference to opposed portions of, or positions on, the pipeline weighting device, as viewed when the device is in place on the longitudinal axis of the pipeline. However, it will be understood that these are terms for relative positional description only, and the pipeline weighting device may generally be used in a flipped (top to bottom, or left to right) position without affecting the functionality of the device.

### BRIEF DESCRIPTION OF THE DRAWINGS

FIGS. 1-5 show one embodiment of the pipeline weighting device, in which:

FIG. 1 is a schematic end view of the pipeline weighting device positioned on the pipeline (looking down the longitudinal axis of the pipeline from the closed end of the device), and showing the optional fastening strap and buckle device.

FIG. 2 is a schematic end view of the pipeline weighting device of FIG. 1 when fastened to the pipeline in a preferred balanced position with four lobes being positioned symmetrically around the pipeline.

FIGS. 3-5 show the pipeline weighting device of FIG. 1 during progressive assembly stages, in which:

FIG. 3 is a top plan view showing the pipeline weighting device fabric pattern as a single web of geotextile fabric, prior to folding and sewing, with the dotted line indicating the center fold line;

FIG. 4 is a top plan view showing the pipeline weighting device after folding on the transverse center line, stitching the longitudinal side edges and fastening the longitudinal lifting straps; and

FIG. 5 is a top plan view showing the pipeline weighting device after stitching along quarter lines to divide into four lobes, fastening the transverse lifting straps, and forming the self-closing fill chutes at the filling ends.

FIGS. 6-9 show another embodiment of the pipeline weighting device, similar to the embodiment of FIGS. 1-5, but modified to include central transverse lifting straps, together with left and right transverse lifting straps which are interconnected to the central transverse lifting straps, in which:

FIG. 6 is a top plan view showing the pipeline weighting device formed with two longitudinal lifting straps positioned centrally at the longitudinal centre line, and showing left and right quarter lines which are double stitched and formed with sets of aligned, transversely spaced apart left and right slots to receive the central, left and right transverse lifting straps.

FIG. 7 is a top plan view of the embodiment of FIG. 6, showing the central transverse lifting straps extending through the sets of spaced left and right slots and looped around the two innermost lobes, left transverse lifting straps extending through the left slots and looped around the left outermost lobe, and right transverse lifting straps extending through the right slots and looped around the right outermost lobe.

FIG. 8 is a schematic sectional view taken along a line perpendicular to the longitudinal axis of the pipeline weighting device of FIG. 7, showing the left, central and right transverse lifting straps interconnected in an inter-looped manner through left and right slots.

FIG. 9 is a schematic end view of the pipeline weighting device showing its folded, M-shape profile when lifted by the central transverse lifting straps for placement on the pipeline located within a pipeline trench.

FIG. 10 is a schematic sectional view of a further embodiment of a pipeline weighting device, similar to the device shown in FIG. 6-9, but including connecting loops at the left and right slots to interconnect the left and right transverse lifting straps to the central transverse lifting straps.

### DESCRIPTION OF THE PREFERRED EMBODIMENTS

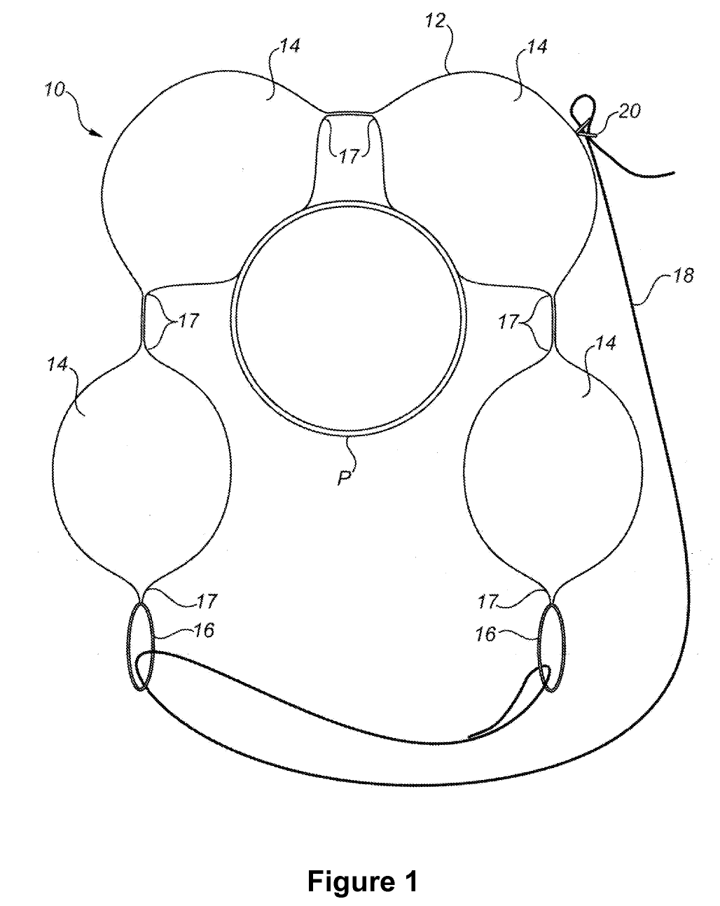

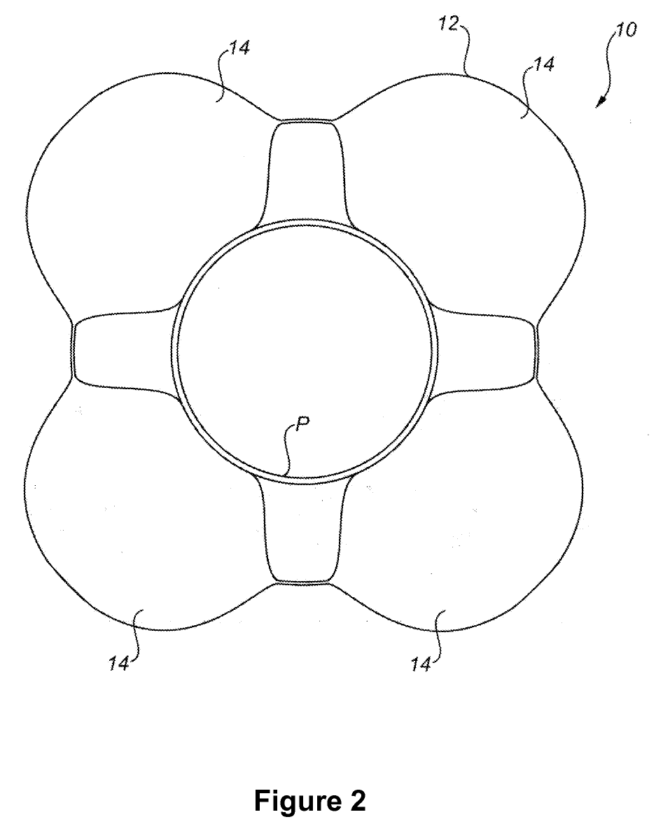

Having reference to FIG. 1, a first embodiment of the pipeline weighting device 10 is shown in a balanced position on pipeline P, with a main bag 12 divided into a plurality (four shown) of symmetrical, generally tubular shaped lobes 14, to be arranged in a preferred and balanced position around the pipeline P. A plurality of lifting loops 16 are shown being formed along the longitudinal side edges 17 of the outermost lobes 14 (i.e., along a longitudinal axis). Optionally, one or more fastening straps 18 may be connected to the side edge 17 of one of the outermost lobes 14, for instance by threading through the lifting loops 16 or by stitching directly to the lobe 14. These fastening straps 18 may be used to fasten the weighting device 10 on the pipeline P. Optionally, one or more buckle devices or buckle means such as D-rings 20 may be provided on the outer side wall of the lobes 14, preferably to a lobe opposite the outermost lobe to which the fastening straps are connected, as shown in the figures. The fastening straps 18 may be threaded through the buckle means to retain the fastening straps 18, as shown in FIG. 1, in order to secure the weighting device 10 to the pipeline. Alternate strap and buckle means may be used to permit tightening and fastening through a buckle device or buckle means. Exemplary alternatives include, without limitation, ratchets, cinches, buckles, slides, clips, rings such as D-rings or O-rings, cam lock sliders, tie downs and hooks. FIG. 2 shows another sectional view, not showing the straps 18 or lifting loops 16, but showing the preferred, symmetrical and balanced configuration of the weighting device 10 on the pipeline P.

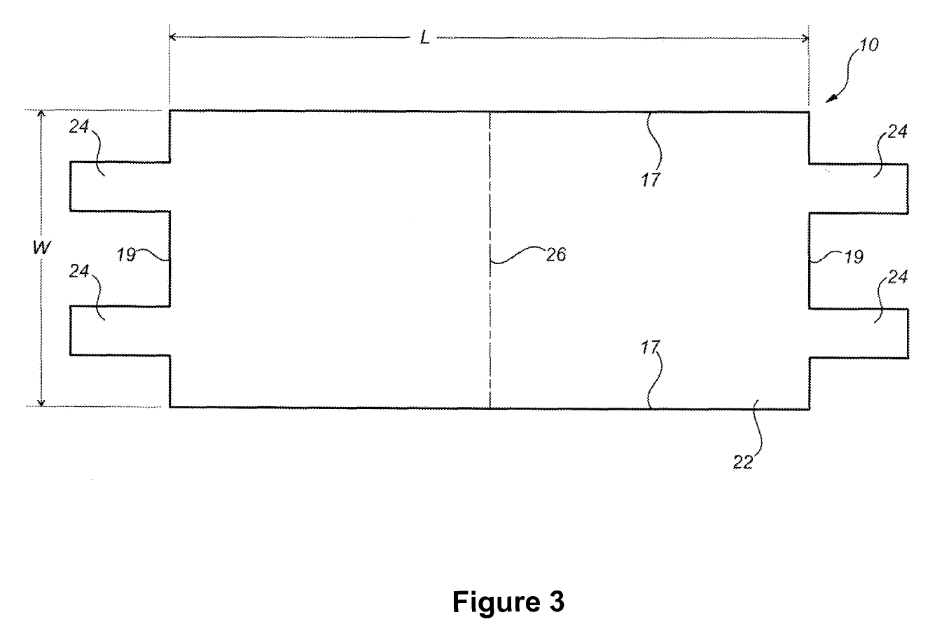

The assembly of the device 10 from a fabric pattern is shown for the first embodiment in FIGS. 3, 4 and 5, described below.

### Assembly

An exemplary fabric pattern for a pipeline weighting device 10 is shown in FIG. 3, in its unassembled form with a main web 22, having a longitudinal length dimension L that is twice the desired finished length of the weighting device 10, and a transverse width dimension W that allows for at least two, and preferably four or more lobes 14 to be subdivided such that an even number of lobes 14 will lie in a balanced manner on the pipeline P in a balanced configuration (see FIGS. 1 and 2). Fill sleeves 24 extend from the transverse (width) ends 19 of the web 22. It will be understood that FIG. 3 shows only one possible fabric pattern, with other patterns being possible within the scope of this invention. For instance, the pattern could provide for folding along a longitudinal axis, such that the pattern had a width dimension twice the desired finished width. Still alternatively, the pattern could provide for two or more fabric sections to be stitched together to form the end device in a manner that will be evident to those skilled in the art.

The fill sleeves 24 are preferably located to be adjacent the longitudinal side edges 17 of the lobes 14 (to be subsequently formed). As shown in FIG. 3, the sleeves 24 are preferably located to straddle the side edges 17 of two adjacent lobes 14 to be subsequently formed.

It will be understood that an alternative to the filling sleeves 24 are filling flaps (not shown), which are arranged to extend into the interior of the lobes, adjacent the longitudinal side edges 17, in a manner so as to form openings to admit fill material into the lobes, but to become trapped within the fill material when the fully charged lobes are turned on the longitudinal axis of the device. Preferably, when a self-closing filling flap is included, it comprises a pair of facing filling flaps forming an opening into the lobe between the facing flaps. The facing flaps preferably have side edges which are at least partially joined to each other such as by stitching along part or all of their side edges.

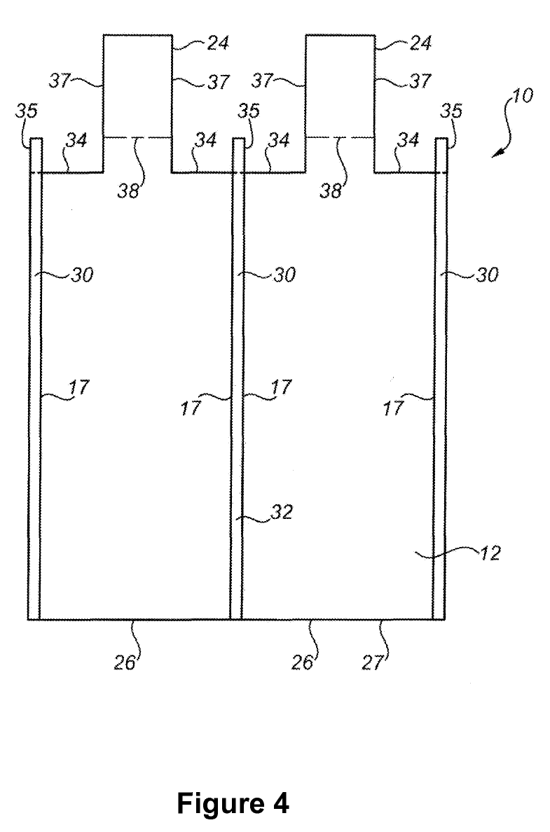

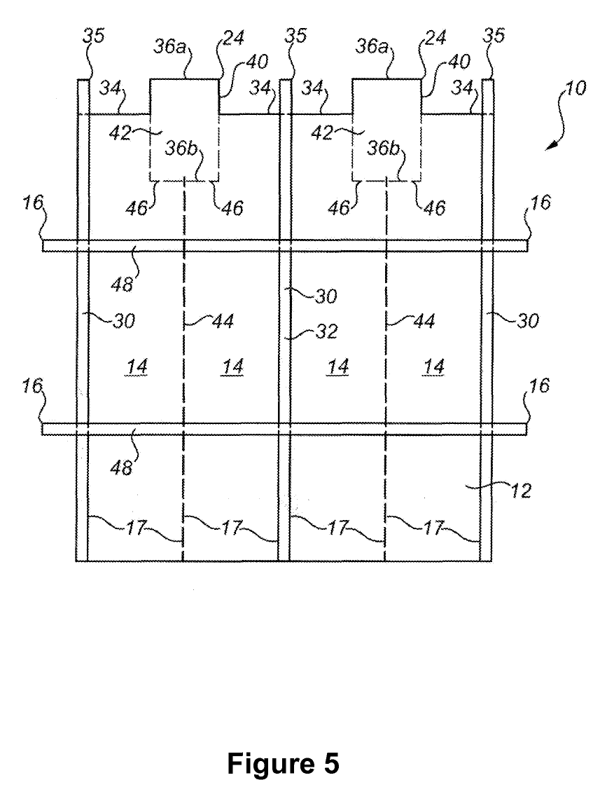

The web 22 is folded lengthwise along fold line 26 to assume the shape shown in partially assembled view of FIG. 4. Alternatively, the web 22 could be formed in two identical sections which are stitched together to assume the shape shown in FIG. 4. The fold line 26, (or a stitched line in the case of two web sections) closes the end of the main bag 12 to form the closed ends 27 (bottom ends) of the lobes 14. In FIG. 4, the web 22 is stitched along its outermost longitudinal side edges 17 to close the sides of the main bag 12. In this assembly operation, flexible lifting straps 30 are preferably simultaneously stitched on both sides of the web 22, along the outermost and inner most longitudinal side edges 17. The main bag 12 is also stitched along its longitudinal centre line 32, preferably also simultaneously stitching a further flexible lifting strap 30 on both sides of the web 22 in this centre line of stitching. The flexible lifting straps 30 form or end in lifting loops 35 at the filling ends 34 to assist in the filling operation, as described below. The main bag 12 is further partially stitched along its filling end 34 (top end) between the filling sleeves 24 (such that openings into lobes 14 are through the filling sleeves 24). In this manner, the filling end 34 of the main bag 12, and of the lobes 14, are open or partially open, as provided for by the filling sleeves 24). The filling sleeves 24 are stitched along part or all of their side edges 37, and are then folded into the interior of the main bag 12, along the fold line 38. In this manner, the filling sleeves 24 form opposed open ends, namely an exterior open end 36a, generally contiguous with the filling end 34 of the bag 12, and an interior open end 36b interior of each lobe 14 (see FIG. 5).

The final steps in the assembly are shown in FIG. 5. The fill sleeves 24 are shown to include a chute portion 40 extending upwardly from the filling ends 34 of the bag 12. This filling chute portion 40 is sized to accept a filling tube or the like (not shown) of an overhead hopper (also not shown) during the later filling operation. Although the chute portion 40 is formed by folding the filling sleeve 24 along a fold line 38 located above the filling ends 34 of the main bag 12, it will be understood that the fold line 38 could be flush with the filling ends 34 of the main bag 12. In either embodiment, the exterior open ends 36a are generally contiguous with the filling end 34 of the main bag 12. An interior portion 42 of the filling sleeve 24 extends into the interior of the main bag 12. The main bag 12 is stitched along quarter lines 44 in order to sub-divide the main bag 12 into the preferred four symmetrical lobes 14. This stitching line along quarter lines 44 also preferably stitches through the interior open ends 36b of the filling sleeves 24, interior of the bag 12, such that the filling sleeves 24 are partitioned to provide openings 46 into each of the lobes 14. The stitching also serves to fix the filling sleeve 24 to the inner side wall of each lobe 14. The openings 46 are sized to allow fill material to freely flow into the lobes 14 during the filling operation. To provide adequate openings, the assembly may include stitching that extends only partly along the sides 37 of the filling sleeves 24, so the sleeve stitching ends before the ends that subsequently form the interior open ends 36b. Alternatively, the shape of the filling sleeve 24 might be flared at the open ends 36b, to increase the size of the openings 46.

Additional flexible lifting straps 48 are attached transversely across the main bag 12, with stitching at the intersections with the first set of lifting straps 30, and optionally at the intersections with the quarter lines 44. The flexible lifting straps 48 end in, form or connect to the lifting loops 16, as shown in FIG. 1.

To ensure that the filling sleeve 24 does become adequately trapped during filling, the filling sleeve 24 preferably extends into the interior of the bag by a distance that is greater than the width of the openings 46 formed at the interior open ends 36b of the sleeves. This ensures that when the sleeve 24 becomes trapped in the fill material during and after filling, there is adequate fabric in the collapsed sleeve to cover and thus close the openings 46 at the open end 36a.

It should be understood that the lifting straps 30 and 48 serve to reinforce the main bag 12 in both the longitudinal and transverse directions, and are thus also termed reinforcing straps. These straps 30, 48 also serve to form or connect to the lifting loops 35, 16 at their ends in a manner to prevent tearing or straining of the lobes 14 of the weighting device 10, once filled with fill material. Smaller bags have a lesser need for the lifting straps 30, 48.

It should also be understood that the fastening straps 18 and D-rings 20 are optional, particularly for very large, heavy bags, which remain balanced on the pipeline P due to their weight factor. Also, other fastening strap embodiments will be evident to one skilled in the art, such as mentioned above, within the scope of the present claims.

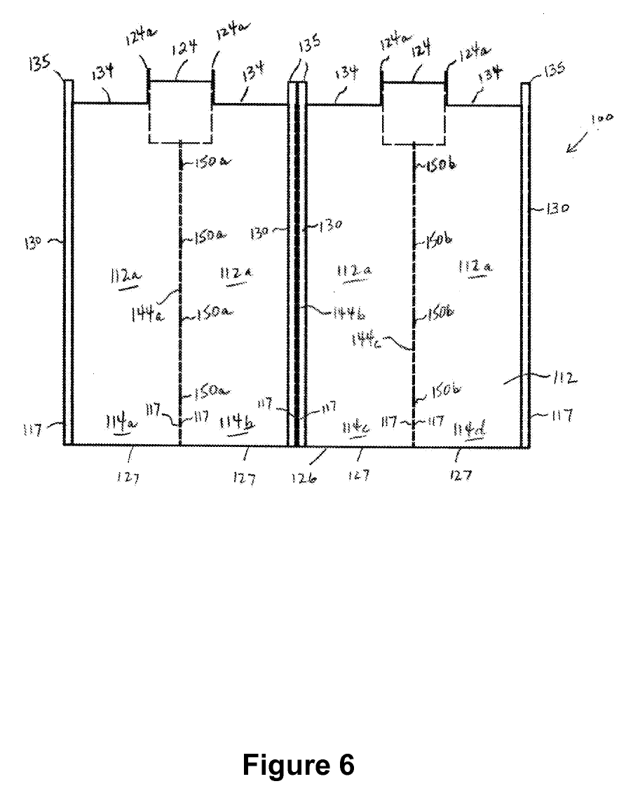

A second embodiment of the pipeline weighting device 100 is shown in FIGS. 6-9 with modifications being made in the longitudinal and transverse reinforcing straps for heavier bags. Features of the second embodiment which are similar or common to features of the first embodiment are labeled with similar numbers, increased by 100, but are otherwise not described in great detail for the second embodiment. Thus, for example filling sleeves 24 in the first embodiment are labeled 124 in the second embodiment, but are otherwise similar to that described above for the first embodiment.

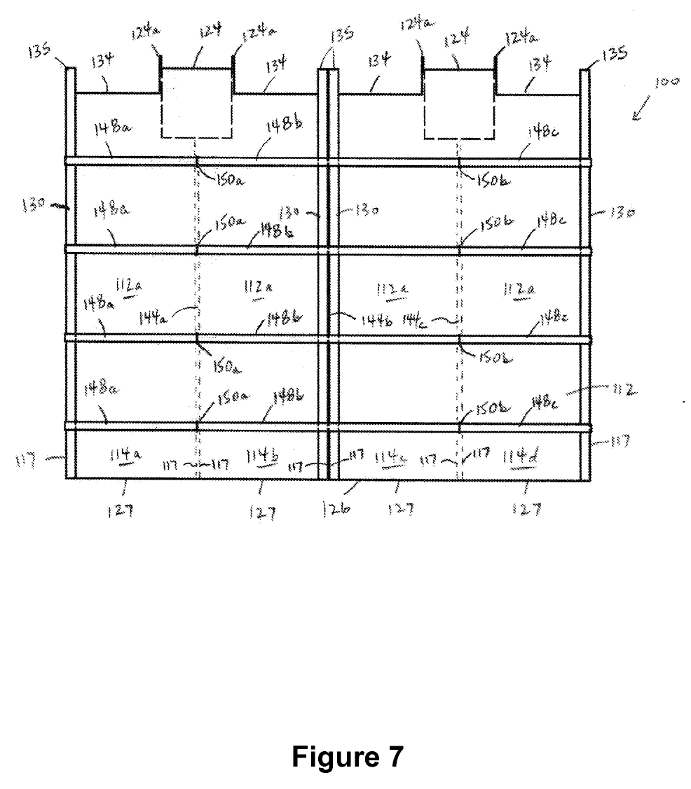

FIGS. 6-9 show the second embodiment formed in four lobes with a left outermost lobe 114a, two innermost lobes 114b, 114c and a right outermost lobe 114d. The number of lobes may vary, but will include one or more left outermost lobes, one or more right outermost lobes and one or more (preferably two or more) innermost lobes, arranged so that the adjacent lobes are interconnected in linear, side by side relationship for balanced placement on the pipeline P. The lobes 114a-114d may be formed from a single web 112 as described above for the first embodiment. Each lobe 114a-114d has an outer side wall 112a formed from the web fabric, once divided or connected into the separate lobes. The bottom edges of the lobes 114a-114d are shown as closed ends 127, and the top edges are shown as filling ends 134, which are partially open through filling sleeves 124. FIGS. 6-9 show this second embodiment with self-closing filling sleeves 124 as described above for FIGS. 1-5, however, alternate types of closures for the filling ends 134 may be used, such as folding over or tying, as known in the art. In FIGS. 6 and 7, each filling sleeve 124 is shown to include left and right sleeve loops 124a at the top open edges of the sleeve 124. These sleeve loops 124a may be used to hold the sleeve 124 in position at the filling tube or nozzle during the filling operation.

The lobes 114a-114d are interconnected by longitudinal seams 144a, 144b and 144c, such as by stitching, welding, or gluing. Stitching may be performed as double row stitching for extra reinforcement at the longitudinal seams 144a-144c. The longitudinal seams 144a-144c permit flexibility and bending longitudinally along the seams, similar to a hinge action. Adjacent lobes 114a and 114b are interconnected by left quarter line longitudinal seam 144a, which thus provides a longitudinal seam between the left outermost lobe and the innermost lobes. Adjacent lobes 114b and 114c are interconnected by centre line longitudinal seam 144b. Adjacent lobes 114c and 114d are interconnected by right quarter line longitudinal seam 144c, which thus provides a longitudinal seam between the right outermost lobe and the innermost lobes. Left and right slots 150a, 150b are formed in each of the left and right quarter line longitudinal seams 144a, 144c. The slots 150a, 150b are adapted to receive left, central and right transverse lifting straps 148a, 148b and 148c as described below. With double row stitching along seams 144a and 144c, the slots 150a, 150b may be formed as cut-outs between the rows of stitching. Extra reinforcing around the slots such as by extra stitching or extra layers of strap or web material at the slot locations, may be used for very heavy bags. The slots 150a, 150b are arranged in sets or rows (each aligned left slot and right slot together forming a pair) so as to be aligned and transversely spaced in the left and right quarter longitudinal seams 144a, 144c (i.e., a plurality of parallel lines may be drawn transversely through each set of aligned, spaced apart slots 150a, 150b in seams 144a, 144b).

Longitudinal reinforcement straps 130, ending in lifting loops 135 may be provided as described above for FIGS. 1-5 (see straps 30, loops 35 described above). These lifting loops 135 may be located at both the filling and closed ends 134, 127 to provide for lifting from one or both of the ends, or only on the filling ends as shown in FIGS. 6, 7. As shown in FIGS. 6-8, double reinforcement straps 130 may also be provided in the central location, that is one on each side of the centre line longitudinal seam 144b, to provide extra reinforcement for very heavy bags. The longitudinal reinforcement straps 130 are attached to the web 112, for example by stitching, prior to attaching the transverse lifting straps 148a-148c.

The longitudinal reinforcement straps are thus located beneath the transverse lifting straps, so as not to interfere with the function of the transverse lifting straps during the lifting operation for pipeline placement. The longitudinal reinforcing straps 130 may be provided on one or both of the top and bottom of the device 100, depending on the extent of reinforcement needed for the size and weight of the device 100. In FIGS. 6 and 7, which are top plan views, the longitudinal reinforcing straps 130 are shown stitched to the top of the device 100, with the stitching extending through three thicknesses (i.e., two web thicknesses and one strap thickness).

A central transverse lifting strap 148b extends through aligned, transverse spaced slots 150a, 150b (in each set of slots 150a, 150b), and encircles the two innermost lobes 114b, 114c to form a loop around the lobes 114b, 114c. A left transverse lifting strap 148a extends through each left slot 150a in the left quarter line longitudinal seam 144a and encircles the left, outermost lobe 114a to form a loop around the lobe 114a. A right transverse lifting strap 148c extends through each slot 150b in the right quarter line longitudinal seam 144c and encircles the right, outermost lobe 114c to form a loop around the lobe 114c. Each left transverse lifting strap 148a is interconnected to an aligned central transverse lifting strap 148b, and each right transverse lifting strap 148c is interconnected to an aligned central transverse lifting strap 148b. The interconnection is located at the longitudinal seam 144a between the left outermost lobe(s) and the innermost lobe(s), and at the longitudinal seam 144c between the right outermost lobe(s) and the innermost lobes(s).

In FIGS. 6-9, the interconnection between the transverse lifting straps 148a, 148b and 148c is located at the slots 150a, 150b formed in the longitudinal seams 144a, 144b respectively. In FIGS. 6-9, this interconnection is achieved by looping one of the straps through the other, and then fastening together the strap ends (for example by stitching) in this inter-looped manner, so as to form three interconnected loops in a row extending transversely across the lobes 114a-114d. To prevent the left or right transverse lifting strap 148a or 148c from traveling along (or riding up along) the central transverse lifting strap 148b, the central transverse lifting strap may be sewn together at the slots 150a, 150b, to trap the left or right transverse lifting strap 148a or 148c within a smaller side loop of the central transverse lifting strap 148b.

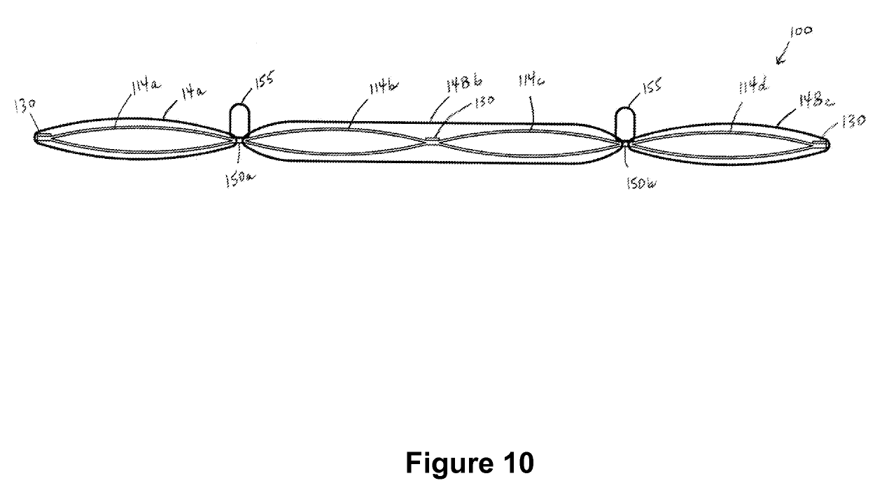

Alternatively, the interconnection between the transverse lifting straps 148a-148c may be provided as shown in a third embodiment of FIG. 10. A connecting loop 155 is provided at each slot 150a, 150b to join together each left transverse lifting strap 148a to each central transverse lifting strap 148b, and to join together each right transverse lifting strap 148c to each central transverse lifting strap 148b.

Still alternatively, the interconnection between the transverse lifting straps 148a-148c may be provided in an embodiment in which the longitudinal seams 144a and 144c are formed with left and right loops respectively, connected to the outer side walls 112a of the lobes on both the top and the bottom of the device. In this embodiment, the left, right and central transverse lifting straps may be interconnected by stitching or by forming the left, right and central transverse lifting straps as an integral transverse lifting strap, and threaded the interconnected or integral transverse lifting strap through the left and right loops. The left and right loops may be formed in continuous strapping stitched along the longitudinal seams 144a, 144c (both top and bottom of device), with the loops being formed by gaps in the stitching. Alternatively the left and right loops may be formed as by discontinuous strapping stitched as loops spaced along the longitudinal seams 144a, 144c (top and bottom of device). The left and right loops are positioned in the locations shown in the FIGS. 6 and 7 for the slots 150a, 150b, so as to form sets of aligned, transversely spaced left and right loops.

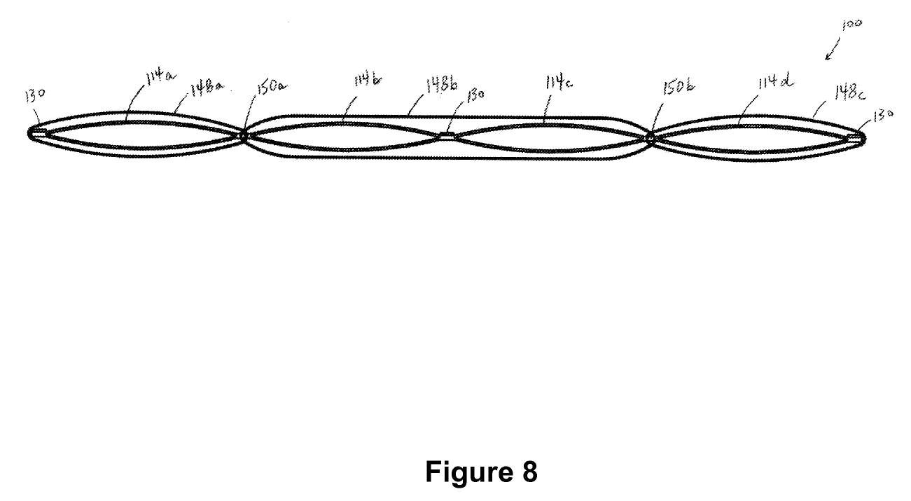

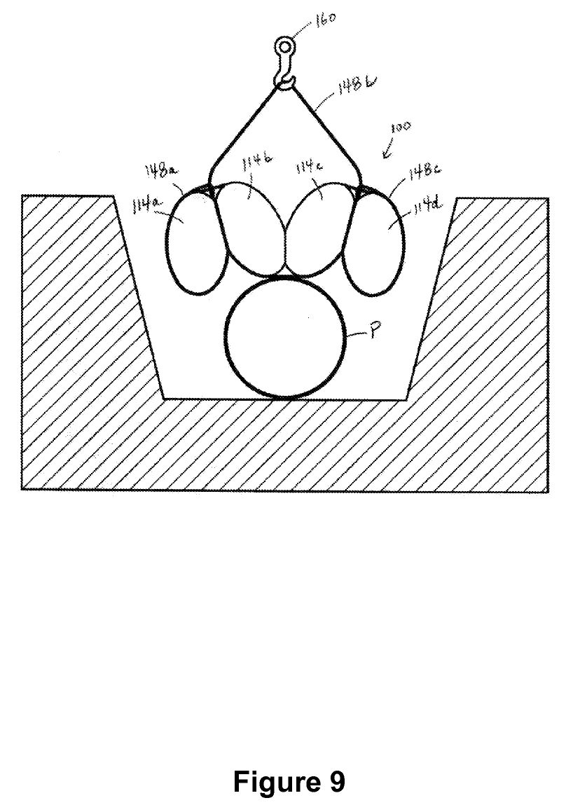

In FIGS. 6, 7 there are shown to be four each of the transverse lifting straps 148a, 148b and 148c, arranged in parallel spaced manner, extending transversely across the lobes 114a-114d. However, more or fewer of these lifting straps 148a-148c may be used, depending on the size and weight of the weighting device 100. FIG. 8 shows a schematic section through aligned, transversely spaced apart slots 150a, 150b. It will be seen that the transverse lifting straps 148a, 148b, 148c extend over the longitudinal reinforcing straps 130, so as to function as loops free of the lobes 114a-114d and free of the straps 130 during lifting. This allows the weighting device 100 to adopt an accordion folded shape (M-shape for four lobes) when a lifting hook 160 is connected to the central transverse lifting straps 148b, as shown in FIG. 9. By interconnecting the central transverse lifting straps 148b to the left and right transverse lifting straps 148a, 148b, directly by inter-looping or through the connecting loops 155, the stress on the weighting device 100 during point lifting with a lifting hook or the like is spread over the lifting straps 148a-148c, across and around the lobes, without placing excessive stress on stitching lines, seams or spot locations on the lobes 114a-114d. This is found to lessen the likelihood of tearing of the lifting straps or the lobes in the very large bag weights. As well, the accordion or M-shape adopted by the weighting device 100 during lifting is compact, with the centre line being easily identified (centre of the M) for balanced placement along the longitudinal axis of the pipeline P. When released from the lifting hook 160, the weighting device 100 unfolds in a balanced and centered manner onto the pipeline P.

The left, central and right transverse lifting straps 148a, 148b, 148c may be provided in the form of loops, such as by stitching, gluing or welding together the ends of a length of strapping after threading through the slots 150a, 150b and interconnecting the straps 148a-148c. A convenient method of forming the loops is by using reinforced stitching at the ends of the strapping (for example box or X-stitching) to ensure the straps 148a-148c are strong enough to support the weight of the filled weighting device 100.

To ensure that the load of the filled lobes 114a-114d is taken by (and transferred by) the transverse lifting straps 148a-148c, and not by the seams 144a-144c, the stitching, or the web material 112 of the lobes 114a-114d, at least the left and right transverse lifting straps 148a, 148c may each have an inside circumference (i.e., surface of strap facing the lobe which it encircles) which is equal to or less than the outer circumference of the filled lobes which they are looped around, i.e., 114a and 114d. Optionally, the central transverse lifting strap 148b may also have an inside circumference which is equal to or less than that needed to fully encircle the innermost lobes 114b and 114c, when in their filled and folded position shown in FIG. 9. This results in the lifting straps 148a, 148c each adopting a tight fit around and against the lobes 114a or 114d when the lobes are fully filled with fill material. Similarly, central transverse lifting straps 148b may adopt a tight fit around and against the innermost lobes 114b, 114c when the lobes are fully filled with fill material. This ensures that, as the weighting device 100 is lifted and suspended by the central lifting straps 148b, the load of the lobes 114a, 114d is taken and transferred by the left and right transverse lifting straps 148a, 148c to the central lifting straps 148b, and not by the stitching, seams or web material of the lobes.

While not shown, fastening straps and buckle devices such as shown for the first embodiments may be included for the second embodiment, although particularly for larger bags, the fastening straps/buckle devices are not needed.

While the above embodiments with transverse lifting straps have been described with four equal sized lobes, three lobes or a greater number of lobes may be used, and the lobes may be different sized relative to one another, provided they are arranged to provide a balanced weight on each side of the pipeline. Thus, for a three lobe weighting device, one or more central transverse lifting straps may encircle a central (innermost) lobe, one or more left transverse lifting strap may encircle a left outermost lobe, and one or more right transverse lifting strap may encircle a right outermost lobe. In a five lobe bag, one or three innermost lobes could be encircled with the central transverse lifting straps, and the remaining two or the remaining one of the outermost lobes could be encircled with the left or right transverse lifting straps. In a six lobe bag, two or four innermost lobes could be encircled with the central transverse lifting straps, and the remaining two or the remaining one of the outermost lobes could be encircled with the left or right lifting straps.

### Filling Operation

The filling operation for the first and second embodiments is similar. Below, the filling operation is described with reference to the first embodiment of FIGS. 1-5. During the filling operation, the main bag 12 is lifted, for example by a fork lift device, by the lifting loops 35 (also termed first lifting loops) to position the chute portions 40 of the filling sleeves 24 below the fill tubes or nozzles (not shown) of an overhead hopper (not shown) filled with weighting fill material (not shown). As the fill material enters each of the lobes 14 through the openings 46 of the filling sleeves 24, it is divided between the adjacent lobes 14. Once the lobes 14 are fully charged with fill material, the fill tubes or nozzles are removed. The main bag 12, and lobes 14 are turned along their longitudinal axis, by lifting the filled bag 12 by the lifting loops 16 (also termed second lifting loops), or by the transverse straps 48. This rotation of the bag 12 on its longitudinal axis shifts the fill material within the lobes 14 in a manner so as to collapse and trap the fill sleeves 24, preventing the fill material from escaping from the bag 12 and lobes 14. In this manner, the bags 12 of the present invention are self-closing, and also self-sealing.

The filling sleeves 24 of the preferred embodiment of this invention have been found to work particularly well in self-closing, as fill material wedges itself between the inner side wall of the lobes 14 and the outer wall of the filling sleeve, causing the sleeve 24 to substantially self-close on itself even during the filling operation. This self-closing action might be envisioned as the collapsing action of an inner flexible sleeve within an outer concentric tubular as the annulus between the sleeve and outer tubular is filled with fill material.

### Pipeline Placement

The filled pipeline weighting device 10 is lifted, for example by the lifting loops 16, or the transverse straps 48 for the embodiment of FIGS. 1-5. For the embodiment of FIGS. 6-9, the central transverse lifting strap 148b is used for lifting by lifting hook 160. A fork lift or crane (not shown) is used to lift the heavier bags. The bag 12 is moved alongside the pipeline P. The weighting device 10 is placed longitudinally along the pipeline, with the centre line 32 along the top center of the pipeline, so as to balance an equal number of lobes 14 on and around the pipeline (as shown in FIGS. 1 and 2). While the weight of the weighting device 10 itself is often sufficient to secure the device 10 to the pipeline P, optional fastening straps 18 might be threaded through the lifting loops 16 to fasten more securely to the pipeline P. As described above, particularly for smaller, lighter weight bags 12, optional D-rings 20 might be located on the lobes 14 to accept and retain the fastening straps 18, in a more secure cinching manner.

The number of lobes 14 in the pipeline weighting device 10 can vary, with an even number being preferred to balance around the pipeline P. Most preferred are four symmetrical lobes 14, as shown above. However, any other even number such as two, six or eight, may be used with a balanced effect. Alternatively, the lobes 14 might be formed asymmetrically, such that one lobe is positioned on top of the pipeline, with an equal number of side lobes extending down the sides of the pipeline in a balanced manner. This configuration is less preferred than shown in the Figures however, since the trench to contain the weighted pipeline might need to be deeper.

While the preferred embodiment includes lobes 14 equally divided from a main bag with stitching, thus forming lobes which are directly connected to each other, and closed, along their longitudinal edges, it should be understood that connecting webs (not shown) might be included between adjacent lobes. For example, a connecting web might be formed between two sets of side lobes, such that the connecting web overlies the top of the pipeline. It is believed that the embodiment of the Figures is preferable over these alternate configurations in order to best minimize any excessive height or depth which the lobes add to the weighted pipeline, so as to minimize any extra trench depth that is needed to contain the weighted pipeline. If additional weight is needed, rather than add extra lobes which will hang well below the bottom of the pipeline, it may be preferable to fasten extra side lobes to the main bag 12, for example by stitching the extra lobes along quarter lines 44. This adds extra width and weight to the weighted pipeline, without extending the height or depth of the weighted pipeline.

Stitching is preferred to divide the main bag 12 into symmetrical lobes 14. However, gluing and/or thermal welding might be used, particularly for smaller bags. The device might include interconnected lobes which are formed separately, and then connected together, for example by stitching. The stitching is done with heavy weight thread, having tensile strength at least as strong as the straps and fabric being used, to prevent tearing or breakage. Double rows (or more rows) of stitching may be used for larger bags to minimize tearing during lifting and filling operations.

Flexible fabric used to make the bags may be woven or non-woven fabric of sufficient strength to contain the fill material. Preferred fabrics include woven or non-woven geotextile fabrics such as polypropylene, with woven polypropylene being most preferred. A fabric weight of 200 g/m² is exemplary (for example 4516 non-woven polypropylene geotextile). The lifting straps (longitudinal and transverse) and lifting loops may be formed of suitably strong industrial strapping materials. Preferred is woven polypropylene, such as 5000 lb/in wide straps. Similarly, if connecting loops 155 are used, they may be formed from strong industrial strapping materials. While metal rings may be used for connecting loops 155, most pipeline applications do not permit the use of conducting metal materials in contact with a pipeline, so strapping material is preferred. Heavy thread and double (or more) stitching is preferred, using thread which is preferably higher tensile strength than the straps.

It will be understood that, particularly for larger, heavier weighting devices, the bag 12 may be formed as a multiwalled bag, for example by starting from multiple webs 22, one on top of another.

One example of suitable dimensions will serve to exemplify the invention. For a 10 inch diameter pipeline, a four lobe pipeline weighting device can be constructed with dimensions of 6 ft×6 ft (length and width dimensions, not filled), to provide a filled weight of about 1100 lb. This produces a pipeline weight which, once placed in a balanced position straddling the pipeline, extends about 7 inches above the pipeline, and 7 inches below the pipeline. While the dimensions may vary, it should be understood that larger lobes, or a greater number of lobes can increase the size of the pipeline weight extending above or below the pipeline itself, increasing the size of the trench needed to bury the weighted pipeline.

Ballast material or fill material includes weight enhancing materials including, without limitation, crushed rock, cement, aggregate, barite or other ores. Dirty aggregate, river rock and sand are less preferred as filling with such materials is more difficult, with clogging being possible.

It will be understood that all of the above-mentioned alternatives, including other alternatives evident to those skilled in the art, are included within the scope of the claims.

Advantages:

Some of the advantages provided by the present invention include:
1. The filling and closing of the weighting device are less labour-intensive, saving time and expense in these operations, and reducing the overall cost of a weighted pipeline with the device of the present invention.
2. The filling and closing operations, as well as the pipeline installation operation are simpler, reducing the likelihood of injury to workers.
3. End filling of the bags is more convenient than open topped bags, lessening spillage and injury to workers thereby.
4. The self-closing and self-sealing filling sleeves lead to reduced spillage, improved dust control.
5. The lifting straps are simple to attach in the fabrication of the device, and offer excellent reinforcement to the bag, with convenient location of the lifting loops.
6. The weighting device can be simply formed from a single web of geotextile fabric in an inexpensive and economical manner.
7. In its preferred embodiment, with equal, even number of lobes (most preferably four symmetrical lobes), the weighting device can be balanced (i.e., with weight equally distributed) around the pipeline, and the depth of the trench needed to contain the pipeline is minimized.

All references mentioned in this specification are indicative of the level of skill in the art of this invention. All references are herein incorporated by reference in their entirety to the same extent as if each reference was specifically and individually indicated to be incorporated by reference. However, if any inconsistency arises between a cited reference and the present disclosure, the present disclosure takes precedence. Some references provided herein are incorporated by reference herein to provide details concerning the state of the art prior to the filing of this application, other references may be cited to provide additional or alternative device elements, additional or alternative materials, additional or alternative methods of analysis or application of the invention.

The terms and expressions used are, unless otherwise defined herein, used as terms of description and not limitation. There is no intention, in using such terms and expressions, of excluding equivalents of the features illustrated and described, it being recognized that the scope of the invention is defined and limited only by the claims which follow. Although the description herein contains many specifics, these should not be construed as limiting the scope of the invention, but as merely providing illustrations of some of the embodiments of the invention.

One of ordinary skill in the art will appreciate that elements and materials other than those specifically exemplified can be employed in the practice of the invention without resort to undue experimentation. All art-known functional equivalents, of any such elements and materials are intended to be included in this invention. The invention illustratively described herein suitably may be practiced in the absence of any element or elements, limitation or limitations which is not specifically disclosed herein.

As used herein, “comprising” is synonymous with “including,” “containing,” or “characterized by,” and is inclusive or open-ended and does not exclude additional, unrecited elements. The use of the indefinite article “a” in the claims before an element means that one or more of the elements is specified, but does not specifically exclude others of the elements being present, unless the contrary clearly requires that there be one and only one of the elements.

We claim:

1. A method of weighting a pipeline along its longitudinal axis, comprising:
a) providing a pipeline weighting device comprising:
a plurality of interconnected, generally tubular-shaped lobes, each lobe having an outer side wall, opposed and closed longitudinal side edges, and opposed ends, one end being a closed end, and the other end forming an open filling end;
one or more fastening straps connected along the longitudinal side edge of an outermost lobe, and one or more buckle devices connected to the outer side wall of a lobe which is opposite the outermost lobe to which the one or more fastening straps is connected; and
the plurality of lobes being formed of a flexible, water permeable fabric to hold the weighting fill material;
b) charging the plurality of lobes with the weighting fill material through their open or partially open filling ends until each lobe includes a balanced, full charge of the weighting fill material, and closing the open or partially open filling end of each lobe;
c) positioning the pipeline weighting device above the pipeline, with the longitudinal axes of the pipeline weighting device and the pipeline being aligned, such that the plurality of lobes are balanced on the pipeline; and
d) fastening the pipeline weighting device to the pipeline by threading the one or more fastening straps through the one or more buckle devices.

2. The method of claim 1, wherein the pipeline weighting device further comprises a plurality of lifting loops formed along the longitudinal side edges of one or both of the outermost lobes, and wherein the one or more fastening straps are connected through the plurality of lifting loops.

3. The method of claim 2, wherein the one or more buckle devices comprises D-rings connected to the outer side wall of one or more of the plurality of lobes.

4. A pipeline weighting device for straddling a longitudinal axis of a pipeline, comprising:
three or more interconnected, generally tubular-shaped lobes arranged in side by side relationship to straddle the pipeline in a balanced manner along the longitudinal axis of the pipeline, each lobe having an outer side wall, opposed and closed longitudinal side edges, and opposed ends, one end being a closed end and the other end forming an open filling end adapted to receive a weighting fill material prior to closing;
the lobes being formed of a flexible water permeable fabric to hold a weighting fill material;
the lobes being interconnected one to another by a longitudinal seam along the longitudinal side edges, and the lobes being arranged as one or more left outermost lobes, one or more right outermost lobes and one or more innermost lobes to straddle the pipeline in the balanced manner;
one or more central transverse lifting straps extending transversely and extending around the one or more innermost lobes;
one or more left transverse lifting straps, each being transversely aligned with one of the one or more central transverse lifting straps, and extending around the one or more left outermost lobes;
one or more right transverse lifting straps, each being transversely aligned with one of the one or more central transverse lifting straps, and extending around the one or more right outermost lobes;
each of the one or more left transverse lifting straps being interconnected with one of the one or more central transverse lifting straps at the longitudinal seam connecting the one or more left outermost lobes to the one or more innermost lobes; and
each of the one or more right transverse lifting straps being interconnected with one of the one or more central transverse lifting straps at the longitudinal seam connecting the one or more right outermost lobes to the one or more innermost lobes.

5. The pipeline weighting device of claim 4, wherein the longitudinal seam connecting the one or more left outermost lobes to the one or more innermost lobes is formed with a plurality of left loops connected to the outer side wall, and the longitudinal seam connecting the one or more right outermost lobes to the one or more innermost lobes is formed with a plurality of right loops connected to the outer side wall, the plurality of left loops and the plurality of right loops being arranged to form sets of aligned, transversely spaced apart left and right loops to accommodate the one or more left transverse lifting straps, the one or more right transverse lifting straps and the one or more central transverse lifting straps.

6. The pipeline weighting device of claim 4, wherein the longitudinal seam connecting the one or more left outermost lobes to the one or more innermost lobes is formed with a plurality of left slots, and the longitudinal seam connecting the one or more right outermost lobes to the one or more innermost lobes is formed with a plurality of right slots, the plurality of left slots and the plurality of right slots being arranged to form sets of aligned, transversely spaced apart left and right slots to accommodate the one or more left transverse lifting straps, the one or more right transverse lifting straps and the one or more central transverse lifting straps such that each of the one or more left transverse lifting straps forms a loop around the one or more left outermost lobes, each of the one or more right transverse lifting straps forms a loop around the one or more right outermost lobes, and each of the one or more central transverse lifting straps forms a loop around the two or more innermost lobes.

7. The pipeline weighting device of claim 6, wherein each of the one or more left transverse lifting straps has an inner circumference sized to form a close fit around the one or more left outermost lobes once the lobes are filled with fill material, and wherein each of the one or more right transverse lifting straps has an inner circumference sized to form a close fit around the one or more right outermost lobes once the lobes are filled with fill material.

8. The pipeline weighting device of claim 7, wherein each of the one or more central transverse lifting straps has an inner circumference sized to form a close fit around the one or more innermost lobes once the lobes are filled with fill material.

9. The pipeline weighting device of claim 7, wherein the lobes are arranged with two or more innermost lobes.

10. A pipeline weighting device for straddling a longitudinal axis of a pipeline, including:
four interconnected, generally tubular-shaped lobes arranged in side by side relationship to straddle the pipeline in a balanced manner along the longitudinal axis of the pipeline, each lobe having an outer side wall, opposed and closed longitudinal side edges, and opposed ends, one end being a closed end and the other end forming an open filling end adapted to receive a weighting fill material prior to closing;
the lobes being formed of a flexible water permeable fabric to hold a weighting fill material;
the lobes being arranged as a left outermost lobe, a right outermost lobe and two innermost lobes;
the lobes being interconnected one to another by a longitudinal seam along the longitudinal side edges so as to form a centre line longitudinal seam between the two innermost lobes, a left quarter line longitudinal seam between the left outermost lobe and one of the innermost lobes, and a right quarter line longitudinal seam between the right outermost lobe and the other of the innermost lobes;
the left and right quarter line longitudinal seams being formed with a plurality of slots, the plurality of slots being arranged so as to form parallel spaced sets of transversely aligned, transversely spaced slots in the left and right quarter line longitudinal seams;
a central transverse lifting strap extending through each set of the transversely aligned, transversely spaced slots and being looped around the two innermost lobes;
a left outer transverse lifting strap extending through each one of the plurality of slots in the left quarter line longitudinal seam, and being looped around the left outermost lobe;
a right outer transverse lifting strap extending through each one of the plurality of slots in the right quarter line longitudinal seam, and being looped around the right outermost lobe;
each left transverse lifting straps being interconnected with one of the central transverse lifting straps; and
each right transverse lifting straps being interconnected with one of the central transverse lifting straps.

11. The pipeline weighting device of claim 10, further comprising a connecting loop positioned at each of the plurality of slots to interconnect one of the left outer transverse lifting straps to one of the central transverse lifting straps, and to interconnect one of the right outer transverse lifting straps to one of the central transverse lifting straps.

12. The pipeline weighting device of claim 10, wherein the central, left and right longitudinal seams are formed by stitching.

13. The pipeline weighting device of claim 12, further comprising:
a left longitudinal reinforcing strap connected along the outermost longitudinal edges of the left outermost lobe, beneath the left transverse lifting straps;
a right longitudinal reinforcing strap connected along the outermost longitudinal edges of the right outermost lobe, beneath the right transverse lifting straps; and
one or more central longitudinal reinforcing straps connected along the center line longitudinal seam, beneath the central transverse lifting strap.

14. The pipeline weighting device of claim 13, wherein the one or more central longitudinal reinforcing straps comprise two reinforcing straps, one on each side of the centre line longitudinal seam.

15. The pipeline weighting device of claim 13, wherein the left, right and central longitudinal reinforcing straps are connected to the lobes by stitching.

16. The pipeline weighting device of claim 13, wherein the centre line longitudinal seam and the left and right quarter line longitudinal seams are each formed by double row stitching, and wherein the plurality of slots are formed between the double row stitching on the left and right quarter line longitudinal seams.

17. The pipeline weighting device of claim 13, wherein the left, right and central longitudinal reinforcing straps and the left, right and central transverse lifting straps are each formed from a flexible, woven or non-woven geotextile strapping material.

18. The pipeline weighting device of claim 13, wherein the left, right and central longitudinal reinforcing straps and the left, right and central transverse lifting straps are each formed from a flexible, woven polypropylene strapping material.

19. The pipeline weighting device of claim 13, wherein the lobes are formed from a flexible, water permeable fabric which is a woven or non-woven geotextile fabric.

20. The pipeline weighting device of claim 13, wherein the lobes are formed from a flexible, water permeable fabric which is a woven polypropylene geotextile fabric.
